(19) United States
(12) Patent Application Publication
(10) Pub. No.: US 2019/0304272 A1
(43) Pub. Date: Oct. 3, 2019

(54) VIDEO DETECTION AND ALARM METHOD AND APPARATUS

(71) Applicant: Shanghai Xiaoyi Technology Co., Ltd., Shanghai (CN)

(72) Inventor: Mengyu Fang, Shanghai (CN)

(73) Assignee: Shanghai Xiaoyi Technology Co., Ltd., Shanghai (CN)

(21) Appl. No.: 16/364,401

(22) Filed: Mar. 26, 2019

(30) Foreign Application Priority Data
Mar. 27, 2018 (CN) 201810259111.2

(51) Int. Cl. G08B 13/196; G06T 7/20; G06K 9/00

(52) U.S. Cl. CPC G08B 13/19602; G06T 7/20; G06K 9/00369; G06T 2207/10016; G06K 9/00228; G06T 2207/30201; G06T 2207/30232; G06K 9/00771

(57) ABSTRACT

A method for triggering an alarm may be provided. The method may include obtaining a video feed including a plurality of video frames, using motion detection to detect a change in the video feed, using human form detection to detect a human form in the video feed, and triggering an alarm based on the human form detected.

### CROSS-REFERENCE TO RELATED APPLICATION

This application is based upon and claims priority from Chinese Patent Application No. 201810259111.2, filed on Mar. 27, 2018, the disclosure of which is expressly incorporated herein by reference in its entirety.

### TECHNICAL FIELD

The present disclosure relates to the field of image processing technology and more particularly to a method for triggering an alarm, video alarm device, storage medium, and web cam.

### BACKGROUND

Motion detection technology, also referred to as movement detection technology, is frequently used for unmanned video surveillance and automated alarms. Generally, motion is detected by comparing video frames using a series of calculations. The video frames may be obtained by a webcam. If the calculations exceed a preset threshold value, a change is deemed to have occurred in the video, triggering an automated alarm or other appropriate response. The change may suggest that the webcam lens has moved or that an object (e.g., a person) has passed within the lens's field of view.

Currently available motion detection technologies are prone to giving false alarms. These alarms are triggered by interference from the external environment such as weather conditions, lighting, shadows, etc.

### SUMMARY

The present disclosure improves the accuracy of motion detection devices to reduce the likelihood of false alarms.

According to a first aspect of the disclosure, a method for triggering an alarm is provided. The method relates to: obtaining a video feed including a plurality of video frames; using motion detection to detect a change in the video feed; using human form detection to detect a human form in the video feed; and triggering an alarm based on the human form detected.

In some embodiments, the alarm is not triggered if a human form has not been detected.

If a human form is detected, facial detection may be performed on an image of the human form to identify it and the alarm may be triggered based on the identification. An image of the human form may be saved once detected.

If a human form is detected, facial detection may be used to obtain a facial image; and perform facial recognition to derive facial information from the facial image. The facial image may be saved after it is obtained.

In some embodiments, the alarm is not triggered if the identification conforms to a predetermined identify criteria; and the alarm is triggered if the identification does not conform to the predetermined identity criteria.

Video frames in which motion is detected may be saved.

According to another aspect of the disclosure, a video alarm system is provided. The system includes a first module configured to obtain a video feed including a plurality of video frames; a second module configured to detect motion and a human form within the video feed; and a third module configured to trigger an alarm based on detection of the human form.

The third module may include a first alarm prompt submodule configured to not issue an alarm prompt when the result of said human form detection indicates that a human form has not been detected.

The third module may include a facial detection submodule configured to perform facial detection on an image of the detected human form to identify the human form; and a second alarm prompt submodule configured to trigger the alarm based on the identification.

The video alarm system may also include a first saving module configured to save an image of said human form.

The facial detection submodule may include a first unit configured to perform facial detection on the image to detect and obtain a facial image of the detected human form; and a second unit configured to perform facial recognition on the facial image to determine facial information.

The video alarm system may also include a second saving module configured to save the facial image after the facial image is obtained.

The second alarm prompt submodule may be configured to trigger the alarm when the identification does not conform to a predetermined identity criteria; and t not trigger the alarm when the identification conforms to the predetermined identity criteria.

The video alarm system may also include a third saving module configured to save, video frames in which motion is detected.

According to another aspect of the disclosure, a storage medium including a computer instruction is provided. When the computer instruction is run, one or more of the steps disclosed herein are executed.

According to another aspect of the disclosure, a webcam including a storage device and a processor are provided. When the processor runs the computer instruction, one or more of the steps disclosed herein are executed.

Embodiments disclosed herein perform human form detection when a change is detected in the video frames and trigger an alarm according to the result of the human form detection. This may significantly improve alarm accuracy and reduce the occurrence of false alarms triggered by changes in the external environment (for example, weather conditions, lighting, other small animals), thereby increasing monitoring efficiency and precision and reducing the disturbance caused by frequent false alarms.

Because embodiments disclosed herein are configured to save an image of detected human forms, they provide the added benefit of allowing a user to confirm the presence of a human form if a false alarm occurs. Using human form detection in conjunction with facial recognition and predetermined identity criteria allows video frames to be filtered to reflect human motion; thereby increasing the accuracy of the alarm and reducing the incidence of false alarms triggered by human forms having nonconforming identities.

It is to be understood that both the foregoing general description and the following detailed description are exemplary and explanatory only and are not restrictive of the invention, as claimed.

### DESCRIPTION OF DRAWINGS

The accompanying drawings, which are incorporated in and constitute a part of this specification, illustrate embodiments consistent with the present disclosure and, together with the description, serve to explain the principles of the present disclosure.

FIG. 1 is a flow diagram illustrating a method for triggering an alarm according to a first aspect of the disclosure;

FIG. 2 is a diagram illustrating an application of the method illustrated in FIG. 1;

FIG. 3 is a structural diagram illustrating a video alarm device according to another aspect of the disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

As previously discussed, currently available motion detection technologies, are prone to false alarms causing inconvenience to users.

The present disclosure overcomes this and other drawbacks of the current technology. According to one aspect, embodiments of the present disclosure perform human form detection when a change in the video frames is detected and determine whether to trigger an alarm based on the human form detection. This may significantly improve alarm accuracy and reduce the occurrence of false alarms caused by changes (e.g., weather, lighting, and small animals) in the external environment, thereby increasing monitoring efficiency and precision and reducing the disturbance caused to users from frequent false alarms.

The above objects, as well as additional objects, features and advantages of the present disclosure, will be more fully appreciated by reference to the following illustrative and non-limiting detailed description.

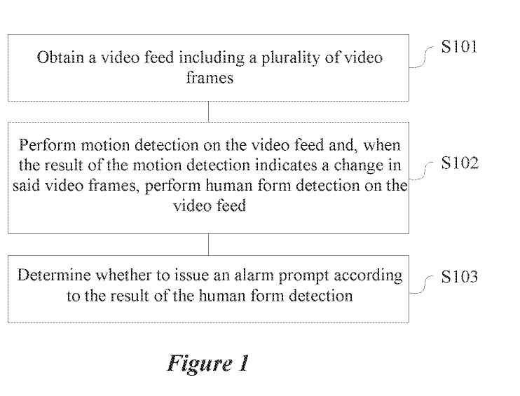

FIG. 1 is a flow diagram illustrating a method for triggering an alarm in according to one aspect of the disclosure.

In Step S101, a webcam may acquire a video feed using various frame rates. The video feed may include a plurality of video frames.

In Step S102, the webcam may perform motion detection on the video feed to complete a preliminary analysis of the video feed. Motion detection technology is the basis of movement video detection technology and is already widely used in many security devices and facilities such as IP cameras, vehicle surveillance locks, infant monitors, automatic samplers, and auto-recognition access control systems.

In one specific embodiment, the webcam may use currently available motion detection algorithms to perform calculations on and compare changes in each video frame of the video feed. When the calculations produce a result that exceeds a predetermined threshold, a change is indicated. Video frames associated with the change may be saved for later viewing and subsequent verification, thereby allowing a user to confirm the presence of a human form.

Generally, motion detection involves calculating the degree of the difference between two video frames (also referred to as image data) in the video feed and, on the basis of calculation results from training and statistics, setting a threshold value for determining whether a change occurs between two video frames.

Each video frame is made up of pixels. Movement may cause the number of pixels to change from frame to frame; therefore, calculating the degree to which the pixel number changes (pixel difference) may serve as a basis for determining movement. In one non-limiting example, a desired pixel difference calculated and used to set the threshold value. Thereafter, if pixel difference between frames exceeds the threshold, the frames may be judged as different.

To ensure accuracy of this judgment, the threshold value may be set to be 20%: when more than 20% of the total number of the pixels differ from one frame to the next, a change is judged to have occurred and motion detection indicates a change in the video frames.

In one non-limiting embodiment, the resolution of the video feed is 1920×1080 (2073600 pixels). If the threshold value for determining whether a change occurred between two video frames is 415000 pixels, then a difference of less than 415000 pixels may not indicate a change. For example, if there are 2000 different pixel points between two video frames, a change may not be judged to have occurred between the two video frames. If, however, the difference exceeds 415000 pixels (e.g., 1400000 pixels) a change may be judged to have occurred between the two video frames. One of ordinary skill in the art will understand that these values are purely illustrative and that they may be adjusted to suit a particular situation and application.

In a further embodiment of the disclosure, human form detection may be performed on the video feed when motion detection indicates that a change has occurred within the video frames. In practice, traditional pedestrian detection feature models or deep learning algorithms may be used to assess the presence of a human form. Once assessed, an image of the human form in said video feed may be marked. Currently available facial detection methods relating to the specific calculation process used in human form detection are known in the art and will not be repeated herein.

In some embodiments, when human form detection indicates that an image of a human form has been detected, an image of the detected human form is be saved for user viewing. The saved image may be used in post-event analysis to verify the presence of a human form and to assess and/or prevent false alarms and missed alarms attributable to webcam recognition error.

In some embodiments, video frames associated with the image of the human form may also be saved to allow a user to retrieve them from the webcam and view the video images to make a determine the human form's identity.

In Step S103, the webcam may determine whether to issue an alarm based on the result of the human form detection.

According to a non-limiting embodiment of the disclosure, if, after motion detection has been performed, it is determined that a change has occurred in said video feed, but no image of a human form is detected after human form detection has been performed, the webcam may only save the video frames in which the change occurred and not issue an alarm prompt.

According to another non-limiting embodiment of the disclosure, if, after motion detection has been performed, it is determined that a change has occurred in the video feed and an image of a human form has been detected, the webcam may save the video frames in which the change occurred, save the image of the human form and issue an alarm prompt. The webcam may connect to a user's cell phone and capture and send a screen shot of the image of the human form to the cell phone once the image of the human form has been detected.

Facial detection may be performed on an image of the detected human form to obtain a facial image. For example, a bounding box may be drawn around a face of the image of the detected human form and facial feature models or deep learning algorithms may be used to assess the face. Currently available facial detection methods relating to the specific calculation process used in facial detection are known in the art; therefore details will not be discussed.

In some embodiments, detected facial images are saved for user viewing. The facial image may be used for post-event analysis to prevent and/or assess false alarms or missed alarms attributable to webcam recognition error.

The webcam may also perform facial recognition on the facial image. In practice, facial recognition compares the facial features in a facial image against facial features in a database to identify the person. The database may be embedded within the webcam, or externally connected to the webcam. Facial information in the database may include facial data that was acquired in advance. The database may be to allow said webcam to perform facial recognition.

According to a non-limiting embodiment of the disclosure, the webcam may be used in a home environment. The user may save the facial information of household members to the database before using the webcam. If a facial image is detected in the video feed acquired by the webcam and cannot be matched to facial information saved in the database after facial recognition is performed, the webcam may trigger an alarm. If the facial image detected in the acquired video feed matches the facial information saved in said database after facial recognition is performed, the webcam does not need to trigger an alarm.

As described above, the video detection method provided by the example embodiment of the present disclosure may significantly improve alarm accuracy, reduce the frequency of false alarms, increase monitoring efficiency and precision, and reduce the disturbance caused to users from frequent false alarms.

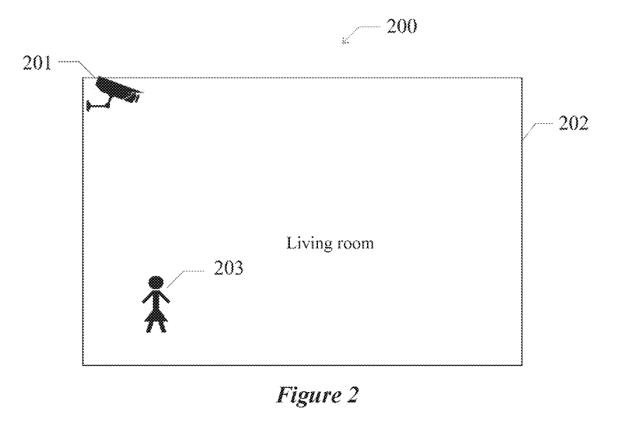

FIG. 2 is a diagram illustrating an application of the method illustrated in FIG. 1.

Referring to FIG. 2, webcam 201 is positioned to target an area to be monitored, e.g., a living room 202. The user may acquire the facial information of household members and save the facial information to webcam 201 or a database (not shown) connected to webcam 201.

When the user and his/her family members leave the home, webcam 201 may be turned on to monitor changes in the home. When webcam 201 discovers that a change has occurred in a captured video feed, the video frames in which the change occurred may be saved and human form detection may be performed. If human form detection indicates that a human form 203 is present, an image of the human form 203 may also be saved and facial recognition may be performed on the image of human form 203. If facial recognition determines that the human form's facial information is not in the database, the human form is identified as a stranger, and an alarm may be triggered. For example, the saved image of the human form 203 may be sent to the user's cell phone to alert the user about the human form as soon as possible.

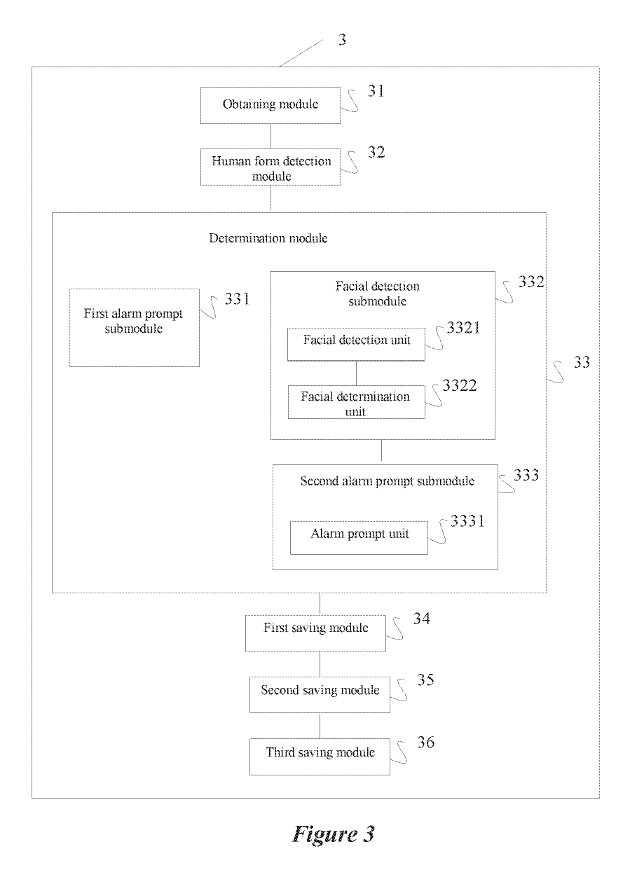

FIG. 3 is a structural diagram illustrating a video alarm device according to another aspect of the disclosure. The video alarm device 3 may include: an obtaining module 31, a human form detection module 32, and a determination module 33.

The obtaining module 31 is configured to obtain a video feed including a plurality of video frames. Human form detection module 32 is configured to perform motion detection on the video feed and human form detection on the video feed when motion detection indicates a change in said video frames. Determination module 33 may include a first alarm prompt submodule 311 and is configured to determine whether to issue an alarm prompt according to the result of the human form detection.

The first alarm prompt submodule 331 is configured to not issue an alarm prompt when the result of said human form detection indicates that a human form has not been detected.

Determination module 33 may also include facial detection submodule 332 and a second alarm prompt submodule 333. Facial detection submodule 332 is configured to perform facial detection on an image of the detected human form when human form detection indicates that a human form has been detected. Second alarm prompt submodule 333 is configured to determine whether to issue an alarm prompt according to the result of the facial detection.

Facial detection submodule 332 may include facial detection unit 3321 and facial determination unit 3322. Facial detection unit 3321 is configured to perform facial detection on the image of the detected human form to obtain a facial image; facial determination unit 3322 is configured to perform facial recognition on the facial image to determine facial information.

Second alarm prompt submodule 333 may include an alarm prompt unit 3331. Alarm prompt unit 3331 does not issue an alarm prompt if the facial information matches preset identity information and issues an alarm prompt when the facial information does not match the preset identity information.

Video alarm device 3 may include first saving module 34. First saving module 34 is configured to save an image of a human form when human form detection indicates that a human form has been detected.

Video alarm device 3 may include a second saving module 35. Second saving module 35 is configured to save the facial image after it has been obtained.

Video alarm device 3 may include a third saving module 36. Third saving module 36 is configured to save video frames associated with changes detected motion detection.

According to another aspect of the disclosure, a storage medium (not shown) is provided on which a computer instruction is stored and methods disclosed herein are executed when the computer instruction is run. The storage medium may include a computer-readable storage medium such as a non-volatile storage device or a non-transitory storage device. The computer-readable storage medium may include a ROM, a RAM, a magnetic disk, or an optical disc, etc.

According to another aspect of the disclosure, a webcam including a storage device and a processor is provided. The storage device stores a computer instruction that can be run on the processor and the methods disclosed herein are executed when the processor runs the computer instruction.

It will be understood that any person having ordinary skill in the art may make various alterations and changes without departing from the essence and scope of the present disclosure. Accordingly, the disclosure is not limited by embodiments disclosed herein and the scope of protection should be that as defined by the claims.

What is claimed is:

1. A method for triggering an alarm, comprising:
obtaining a video feed including a plurality of video frames;
using motion detection to detect a change in the video feed;
using human form detection to detect a human form in the video feed; and
triggering an alarm based on the human form detected.

2. The method of claim 1, wherein when human form detection does not detect a human form, the alarm is not triggered.

3. The method of claim 1, further comprising:
performing facial detection on an image of the human form to identify the human form; and
triggering the alarm based on the identification.

4. The method of claim 3, further comprising:
saving the image of the human form.

5. The method of claim 3, wherein the facial detection is used to acquire a facial image of the human form and perform facial recognition of the facial image to obtain facial information.

6. The method of claim 5, further comprising:
saving the facial image after the facial image is obtained.

7. The method of claim 5,
wherein when the identification conforms to a predetermined identity criteria, the alarm is not triggered, and
wherein the alarm is triggered when the identification does not conform to the predetermined identity criteria.

8. The method of claim 1, further comprising:
saving video frames in which the change is detected.

9. A video alarm device, comprising:
a first module configured to obtain a video feed including a plurality of video frames;
a second module configured to detect motion and a human form within the video feed; and
a third module configured to trigger an alarm based on detection of the human form.

10. The device of claim 9, wherein the third module comprises:
a first alarm prompt submodule configured to not issue an alarm prompt when the result of said human form detection indicates that a human form has not been detected.

11. The device of claim 9, wherein the third module comprises:
a facial detection submodule configured to perform facial detection on an image of the detected human form to identify the human form; and
a second alarm prompt submodule configured to trigger the alarm based on the identification.

12. The device of claim 11, further comprising:
a first saving module configured to save the image of the human form.

13. The device of claim 11, wherein the facial detection submodule comprises:
a first unit configured to perform facial detection on the image to detect and obtain a facial image of the detected human form; and
a second unit configured to perform facial recognition on the facial image to determine facial information.

14. The device of claim 12, further comprising:
a second saving module configured to save the facial image after the facial image is obtained.

15. The device of claim 13,
wherein the second alarm prompt submodule is configured to trigger the alarm when the identification does not conform to a predetermined identity criteria, and
wherein when the identification conforms to the predetermined identity criteria, the second alarm prompt submodule is configured not to trigger the alarm.

16. The device of claim 14, further comprising:
a third saving module configured to save video frames in which the motion is detected.

17. A storage medium, comprising:
a computer instruction, wherein when the computer instruction is run, the video detection and alarm method of claim 1 is executed.

18. A webcam, comprising:
a storage device including a computer instruction; and
a processor configured to run the computer instruction,
wherein when the processor runs the computer instruction, the video detection and alarm method of claim 1 is executed.
